(19) United States
(12) Patent Application Publication
(10) Pub. No.: US 2023/0196210 A1
(43) Pub. Date: Jun. 22, 2023

(54) UTILIZING MACHINE LEARNING MODELS TO PREDICT CLIENT DISPOSITIONS AND GENERATE ADAPTIVE AUTOMATED INTERACTION RESPONSES

(71) Applicant: Chime Financial, Inc., San Francisco, CA (US)

(72) Inventors: Alan Bustelo-Killam, Fremont, CA (US); Niranjan A. Shetty, Berkeley, CA (US); Daniel Corin, San Francisco, CA (US); Alex Dotterweich, Brooklyn, NY (US); Greg Tobkin, San Francisco, CA (US); Inhye Kim, San Mateo, CA (US)

(21) Appl. No.: 17/554,795

(22) Filed: Dec. 17, 2021

(51) Int. Cl. G06N 20/20; G06F 9/451

(52) U.S. Cl. CPC G06N 20/20; G06F 9/453; G06F 3/167

(57) ABSTRACT

The present disclosure relates to systems, non-transitory computer-readable media, and methods for utilizing a machine learning model to determine a predicted client disposition classification and generate an automated interaction response. For example, disclosed systems utilize the machine learning model to generate a predicted client disposition classification and a corresponding disposition classification probability. The disclosed systems can utilize the predicted client disposition classification, the disposition classification probability, and a disposition classification threshold to generate an automated interaction response that references the predicted client disposition classification. Moreover, the disclosed systems can provide the automated interaction response to a client device, bypassing the inefficiency of menu options or protocols utilized to guide clients to terminal information.

### BACKGROUND

Recent years have seen significant improvements in conventional systems for utilizing computing devices to interact with various clients and client devices. For example, conventional systems can utilize computer-implemented chat bots or heuristic menu structures to guide clients through various options and identify desired information or services. To illustrate, conventional systems can provide a menu of selectable voice options or user interface elements that allow clients to iteratively select pertinent information. For example, in response to a client selection of a first option, conventional systems often present (e.g., through voice interaction) a sub-menu of options to further focus the interactive session.

Although conventional systems can autonomously interact with clients, these conventional systems have a number of problems in relation to accuracy, efficiency, and flexibility of implementing computing devices. For instance, conventional systems are often inaccurate in guiding clients/client devices to pertinent resources. For example, based on interactions with menu options and/or voice options, conventional systems often route clients to an inaccurate terminal path that fails to provide the needed information or resources. Indeed, because conventional systems broadly generalize menu and sub-menu options this leads the system to route clients to information that is inapplicable and inaccurate.

In addition, conventional systems are also inefficient. For example, inaccurately routing clients increases the overall burden on implementing devices resulting from longer interaction times, additional interactions and/or interfaces, and increased routing to agent devices. Indeed, conventional systems often require excessive interaction with user interfaces or voice interaction protocols. Specifically, an automated client interaction system that interacts with clients via a text display list of menu options (or verbal list of options) can require numerous user input interactions. Such interactions place additional unnecessary burdens on computational resources of implementing devices. In conventional systems, the litany of steps required for the system to narrow down the reason for the client contact results in excessive interactions and wasted computing resources.

In addition, conventional systems are often inflexible and rigid. For example, conventional systems often utilize a rigid menu structure of options that clients must utilize in order to obtain pertinent information. Accordingly, conventional systems inflexibly present this menu of options to clients regardless of the nature or context of the interaction. This inflexibility exacerbates the accuracy and efficiency concerns discussed above. These along with additional problems and issues exist with regard to conventional automated client interaction systems.

### BRIEF SUMMARY

This disclosure describes one or more embodiments of methods, non-transitory computer-readable media, and systems that can solve the foregoing problems in addition to providing other benefits by generating automated interaction responses based on predicted client dispositions generated from a machine learning model. For example, the disclosed systems extract client features and use a machine learning model to generate a predicted client disposition and a corresponding disposition probability. Moreover, the disclosed system utilize the predicted client disposition and disposition probability to generate an automated interaction voice response. To illustrate, the disclosed systems can compare a disposition probability to a disposition threshold and, in response, generate an automated interaction voice response that references the predicted client disposition. Additionally, the disclosed systems can provide the automated interaction voice response to the client bypassing menu options or other structures for routing a client device to pertinent information. In this manner, the disclosed systems can generate accurate automated interaction responses that efficiently and flexibly guide client devices to pertinent resources.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a block diagram of an environment for implementing an automated client interaction system in accordance with one or more embodiments.

FIG. 2A illustrates an example diagram of an automated client interaction system that utilizes a machine learning model to generate automated interaction responses in accordance with one or more embodiments.

FIG. 2B illustrates an example graphical user interface on a client device in accordance with one or more embodiments.

FIG. 3 illustrates an example diagram of an automated client interaction system initiating a client-agent response session in accordance with one or more embodiments.

FIG. 4 illustrates an example diagram of an automated client interaction system training a machine learning model in accordance with one or more embodiments.

FIG. 5 illustrates an example diagram of an automated client interaction system generating predicted client disposition classifications and probabilities in accordance with one or more embodiments.

FIG. 6 illustrates an example diagram of an automated client interaction system comparing disposition probabilities to disposition thresholds in accordance with one or more embodiments.

FIG. 7 illustrates a precision-recall curve for an example machine learning model in accordance with one or more embodiments.

FIG. 8 illustrates an example series of acts for generating an automated interaction response in accordance with one or more embodiments.

FIG. 9 illustrates a block diagram of a computing device for implementing one or more embodiments of the present disclosure.

FIG. 10 illustrates an example environment for an automated client interaction system in accordance with one or more embodiments.

### DETAILED DESCRIPTION

This disclosure describes one or more embodiments of an automated client interaction system that utilizes a trained machine learning model to predict client dispositions (e.g., contact reason or contact intent) and generate automated interaction responses for client devices. To elaborate, the automated client interaction system can utilize a decision tree model (such as a gradient boost machine or random forest machine learning model) trained based on historical client interactions to generate an automated interaction response to the client based on a predicted disposition. For example, the automated client interaction system can extract features from a client device and analyze those features using a machine learning model to generate a predicted disposition classification and a disposition classification probability for the client. Furthermore, the automated client interaction system can generate a response for the client using the predicted disposition classification, disposition classification probability, and a disposition classification threshold. For example, the automated client interaction system can generate and provide an automated interaction response that references the predicted disposition classification in response to determining that the disposition classification probability satisfies the disposition classification threshold. In one or more embodiments, the automated client interaction system monitors interactions between client and the automated client interaction system to compare actual client dispositions with predicted client disposition classifications and further trains the machine learning model based on this comparison. In this manner, the automated client interaction system can improve the efficiency, accuracy, and flexibility of implementing computing devices in managing client interactions.

As just mentioned, the automated client interaction system extracts client features corresponding to a client. These features are then used in the machine learning model to generate a predicted disposition of the client. For instance, the automated client interaction system can monitor client device interactions, determine client device characteristics, and access digital accounts corresponding to the client to extract features. To illustrate, in response to receiving a query from a client device, the automated client interaction system can determine a client's recent activity or previous dispositions from interactive sessions.

Upon determining client features, the automated client interaction system utilizes a machine learning model to generate predicted client dispositions. For example, in one or more implementations the automated client interaction system utilizes, a random forest model, or a gradient boosted decision tree (such as LightGBM) to generate predicted client dispositions (e.g., classifications corresponding to a particular intent or purpose of the client interaction). To illustrate, the automated client interaction system utilizes a trained random forest model to analyze the extracted client features from the client interaction to generate a predicted client disposition and a disposition probability. For instance, the machine learning model can predict that the client seeks pertinent information regarding a direct deposit status and that the prediction has a 75% probability of holding true.

As mentioned above, the automated client interaction system can utilize a disposition classification probability in tandem with a predicted disposition classification to generate an automated interaction response. For example, the automated client interaction system can compare the disposition classification probability with the disposition classification threshold. Upon determining that the disposition classification threshold is satisfied, the automated client interaction system can generate an automated interaction response that references the predicted disposition classification. Alternatively, if the automated client interaction system determines that the disposition classification threshold is not satisfied, the automated client interaction system can withhold an automated response corresponding to the prediction.

The automated client interaction system can generate a variety of automated interaction responses. For example, in some implementations the client interaction system generates an automated interaction voice response that references the predicted client disposition. To illustrate, the client interaction system can generate a prompt to confirm that the client needs information regarding the predicted client disposition. In some embodiments, the client interaction system generates an automated interaction response that includes a response or answer corresponding to the predicted client disposition (e.g., providing an answer to a predicted client question).

In one or more implementations, the automated client interaction system initiates a client-agent response session based on a predicted client disposition and/or automated interaction response. For example, the automated client interaction system can initiate a client-agent response session in response to determining that a predicted disposition probability exceeds an agent probability threshold. Similarly, the automated client interaction system can initiate a client-agent response session in response to detecting a user interaction with an automated interaction response (e.g., a user interaction confirming that the predicted disposition classification is accurate). In some embodiments, the automated client interaction system provides the predicted client disposition to an agent device to further reduce time and resources utilized in completing an interaction sequence.

As mentioned above, the automated client interaction system can train the machine learning model. In some embodiments, the automated client interaction system trains the machine learning model to utilize extracted client features and monitored client dispositions as ground truths for supervised training. In some implementations, the automated client interaction system utilizes predicted disposition classifications for a client device and monitored interactions to further train the machine learning model. Indeed, by monitoring client interactions, after a predicted disposition classification, the automated client interaction system can determine actual dispositions. The automated client interaction system can compare a ground truth client disposition classification with a predicted disposition classification and further train and improve the machine learning model.

As suggested above, the disclosed automated client interaction system provides several improvements or advantages over conventional systems. For example, the automated client interaction system can improve the inaccuracy of conventional systems by predicting client dispositions and routing client devices to pertinent information and resources. For example, by utilizing a trained machine learning model and extracted features corresponding to a request, the automated client interaction system can predict an accurate client disposition without utilizing conventional menu options or voice interaction protocols. Moreover, the automated client interaction system can generate and provide accurate automated interaction responses. Accordingly, the automated client interaction system can utilize implementing computer devices to determine and provide accurate data to client devices.

In addition, the automated client interaction system can improve inefficiencies of conventional systems by reducing the overall burden on implementing devices. For example, the automated client interaction system can utilize a trained machine learning model to generate predicted client dispositions and generate automated interaction responses. Accordingly, the automated client interaction system can reduce interaction times, user interfaces, and computing resources in interacting with client devices. Indeed, by reducing the number of user inputs, interfaces and interaction times, the automated client system can reduce unnecessary burdens on computing resources. Furthermore, in some embodiments, the automated client interaction system generated predicted dispositions utilizing an updated frequency (e.g., 10% of the entire client cohort, ten times an hour) to efficiently determine predicted dispositions without sacrificing accuracy. Overall, the automated client interaction system can reduce unnecessary burdens on computational resources, stabilize overall performance and improve efficiency.

The automated client interaction system can also improve the inflexibility and rigidity of conventional systems. For example, the automated client interaction system can generate predicted client disposition and provide automated interaction response that reflect the particular context of a client query. In doing so, the automated client interaction system can flexibly bypass rigid menus or operational structures that plague conventional systems. Indeed, the automated client interaction system can flexibly generate pertinent automated interaction responses, provide requested information without menu options, and/or flexibly route client devices to agent devices to access specific resources.

As indicated by the foregoing discussion, the present disclosure utilizes a variety of terms to describe features and advantages of the automated client interaction system. For example, as used herein, the term “predicted client disposition classification” refers to a class or category indicating a purpose, intent, reason or objective for a client interaction. In particular, the term “predicted client disposition classification” can include a probable intention of the client, determined by a machine learning model's trained past interaction with the automated client interaction system, and informed by client features. To illustrate, a “predicted client disposition classification” can include a prediction that a client is interacting with the automated client interaction system to inquire about a direct deposit status, interaction history, and/or device fee information.

As mentioned above, the automated client interaction system can identify client queries. As used herein, the term “client query” refers to an interaction that a client has with the automated client interaction system. In particular, the term “client query” can include a question directly posed to the automated client interaction system, a statement posed to the automated client interaction system, or an interaction in context with previous client interactions. To illustrate, a client query can include a client device initiating a chat text thread or voice session to obtain a response from the automated client interaction system.

As discussed, the automated client interaction system can extract client features for use by the machine learning model. As used herein, the term “client features” refers to attributes, characteristics, behaviors, and/or interactions corresponding to a client. In particular, the term “client features” can include previous interactions, client balance, digital account status, and recent activity. To illustrate, client features can include that the client has opened an account for a total of two months, that the client has initiated contact with the automated client interaction system five times in the past week, or that the client had recently received a communication regarding security issues with an account.

In one or more embodiments, the automated client interaction system uses a machine learning model. As used herein, the term “machine learning model” refers to a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks).

In addition, the automated client interaction system can use a machine learning model to generate a disposition classification probability. As used herein, the term “disposition classification probability” refers to a likelihood of a particular disposition classification. In particular, the term “disposition classification probability” can include a probability that a client is interacting with the automated client interaction system for a predicted client disposition classification. To illustrate, a disposition classification probability can include a 65% probability that a client is initiating a voice session or chat session to inquire about a direct deposit status.

As mentioned above, the automated client interaction system can generate an automated interaction response. As used herein, the term “automated interaction response” refers to an interaction with a client (e.g., generated automatically, without user input). In particular, the term “automated interaction response” can include a response to a client query provided via a client device. To illustrate, an automated interaction response can include a question asking the client to confirm a predicted client disposition.

The automated client interaction system can also initiate a client-agent response session. As used herein, the term “client-agent response session” refers to an interaction between a client and agent. In particular, the term “client-agent response session” can include a client device interacting with an agent device through text or an oral response.

As discussed, the automated client interaction system can further train the machine learning model with a ground truth client disposition. As used herein, the term “ground truth client disposition” refers to a known observation or result. In particular, the term “ground truth client disposition” can include a known disposition of a client. To illustrate, a “ground truth client disposition” can include a known purpose or intent for a previous interaction from the client.

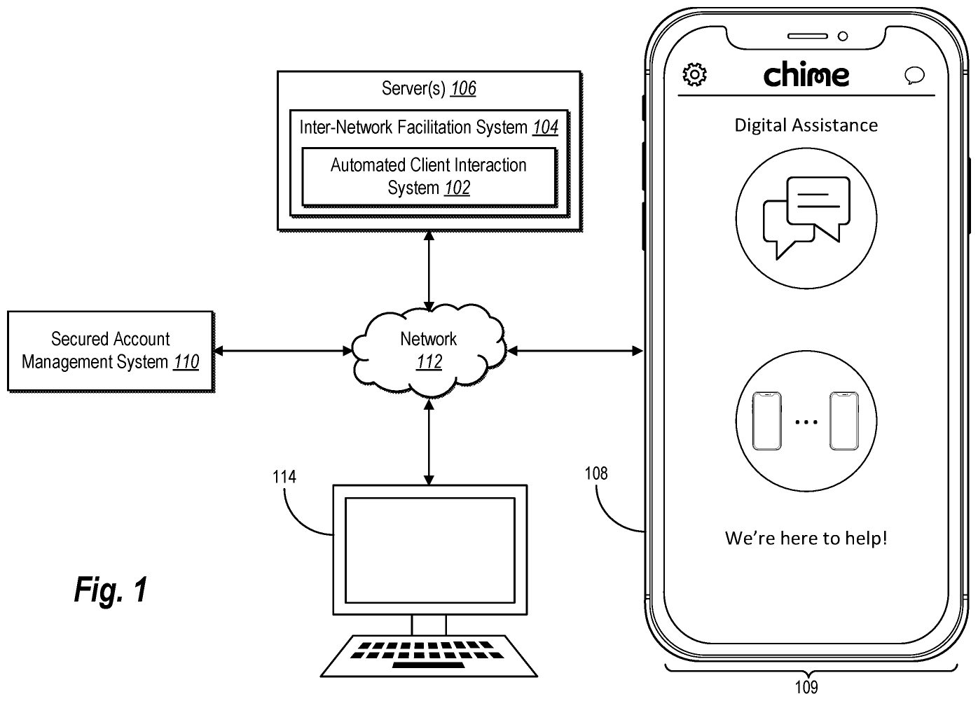

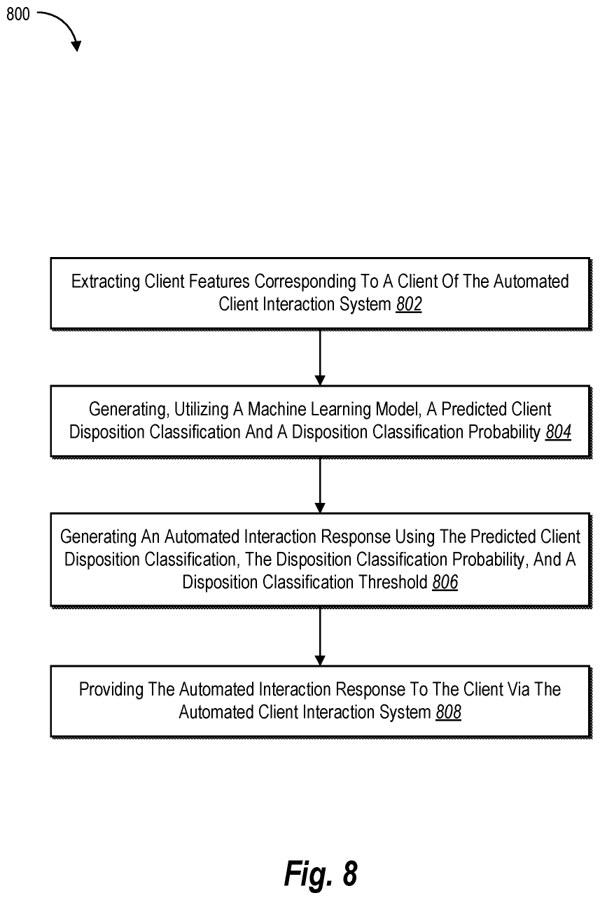

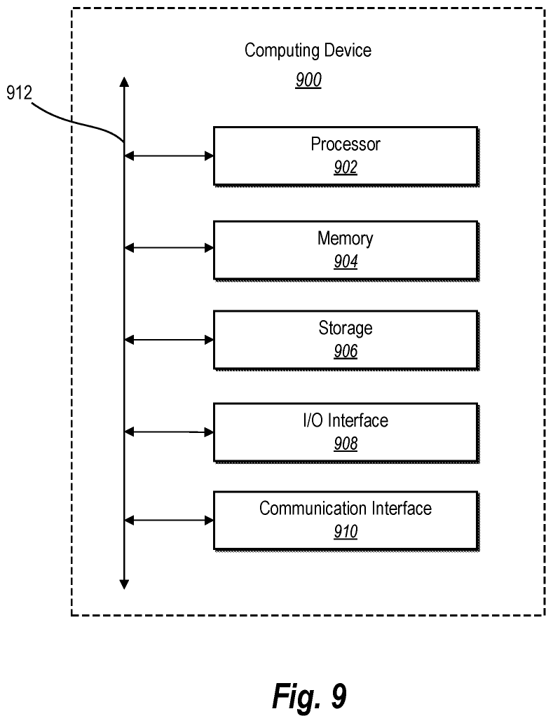

Additional detail regarding the automated client interaction system will now be provided with reference to the figures. In particular, FIG. 1 illustrates a block diagram of a system environment for implementing an automated client interaction system 102 in accordance with one or more embodiments. As shown in FIG. 1, the environment includes server(s) 106 implementing the automated client interaction system 102 as part of an inter-network facilitation system 104. The environment of FIG. 1 further includes a client device 108, a device application 109, an agent device 114, and a secured account management system 110. The server(s) 106 can include one or more computing devices to implement the automated client interaction system 102. Additional description regarding the illustrated computing devices (e.g., the server(s) 106, the client device 108, the agent device 114 and/or the secured account management system 110) is provided with respect to FIGS. 8-9 below.

As shown, the automated client interaction system 102 utilizes the network 112 to communicate with the client device 108, the agent device 114 and/or the secured account management system 110. The network 112 may comprise a network as described in relation to FIGS. 8-9. For example, the automated client interaction system 102 communicates with the client device 108 to provide and receive information pertaining to various client interactions. Indeed, the inter-network facilitation system 104 or the automated client interaction system 102 can provide an automated interaction response to the client device 108 or can facilitate a session between the agent device 114 and the client device 108.

As described in greater detail below (e.g., in relation to FIG. 9), the inter-network facilitation system 104 can manage interactions across multiple devices, providers, and computer systems. For example, the inter-network facilitation system 104 can execute transactions across various third-party systems such as a banking entities, automated transaction machines, or payment providers. The inter-network facilitation system 104 can also maintain and manage digital accounts for client devices/users to store, manage, and/or transfer funds to other users.

To facilitate automated interaction responses, in some embodiments, the inter-network facilitation system 104 or the automated client interaction system 102 communicates with the secured account management system 110. More specifically, the inter-network facilitation system 104 or the automated client interaction system 102 determines the identity and permissions of the client device 108 by communicating with the secured account management system 110. The automated client interaction system 102 can determine permissions of the client device 108 prior to disclosing secure information to the client device 108. For example, the inter-network facilitation system 104 or the automated client interaction system 102 accesses a secured account maintained by the secured account management system 110 (e.g., remotely from the server(s) 106) and determines the last direct deposit within the secured account.

In one or more embodiments, the inter-network facilitation system 104 or the automated client interaction system 102 communicates with the secured account management system 110 in response to the automated client interaction system 102 receiving identification information from the client device 108. In particular, the inter-network facilitation system 104 or the automated client interaction system 102 provides an indication of a secured account associated with a digital account to indicate that the client device 108 is authorized to receive information pertaining to the digital account. In addition, the inter-network facilitation system 104 or the automated client interaction system 102 communicates with the secured account management system 110 to determine permissions of the client device 108. For example, the inter-network facilitation system 104 or the automated client interaction system 102 provides information to the client device 108 such as direct deposit status, digital account updates, device fee information, check status, interaction history, order status, activation, etc.

As indicated by FIG. 1, the client device 108 includes the device application 109. In particular, the device application 109 can include a web application, a native application installed on the client devices 108 (e.g., a mobile application, a desktop application, etc.), or a cloud-based application where all or part of the functionality is performed by the server(s) 106. In some embodiments, the inter-network facilitation system 104 or the automated client interaction system 102 communicates with the client device 108 through the device application 109. This communication for example, receives and provides information including direct deposit status, digital account updates, device fee information, check status, interaction history, order status, activation, etc. As shown, the automated client interaction system 102 can provide digital account information and secured account information for display within a graphical user interface associated with the device application 109 or can provide digital account information via other methods such as a voice protocol response. An interactive voice response can occur between the client device 108 and the inter-network facilitation system 104 or the automated client interaction system 102. On the other hand, the inter-network facilitation system 104 or the automated client interaction system 102 can provide a graphical user interface that includes digital account information pertaining to the client device 108.

As shown in FIG. 1, the client device 108 implements the device application 109 in conjunction with interaction with the inter-network facilitation system 104 or the automated client interaction system 102. For example, the inter-network facilitation system 104 or the automated client interaction system 102 can monitor the activities of the device application 109. In particular, these activities can include events such as time spent on device application 109, recently viewed pages on device application 109, the most recent activation activity of the device application 109, etc.

Although FIG. 1 illustrates the environment having a particular number and arrangement of components associated with the automated client interaction system 102, in some embodiments, the environment may include more or fewer components with varying configurations. For example, in some embodiments, the inter-network facilitation system 104 or the automated client interaction system 102 can communicate directly with the client device 108, device application 109, and/or the secured account management system 110, bypassing the network 112. In these or other embodiments, the inter-network facilitation system 104 or the automated client interaction system 102 can be implemented (entirely on in part) on the client device 108. Additionally, the inter-network facilitation system 104 or the automated client interaction system 102 can include or communicate with a database for storing information, such as direct deposit status, digital account updates, device fee information, check status, interaction history, order status, activation, and/or other information described herein.

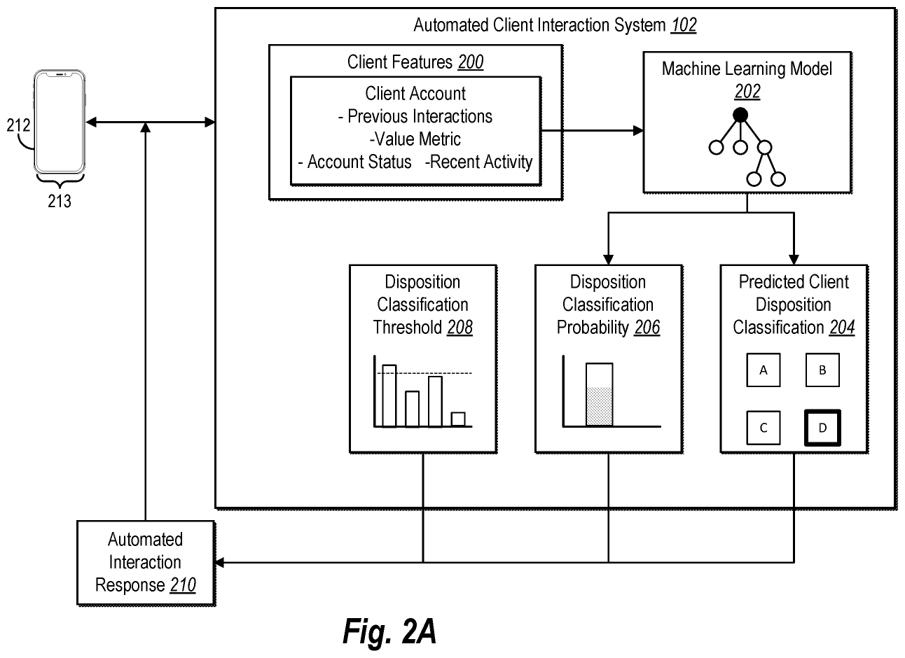

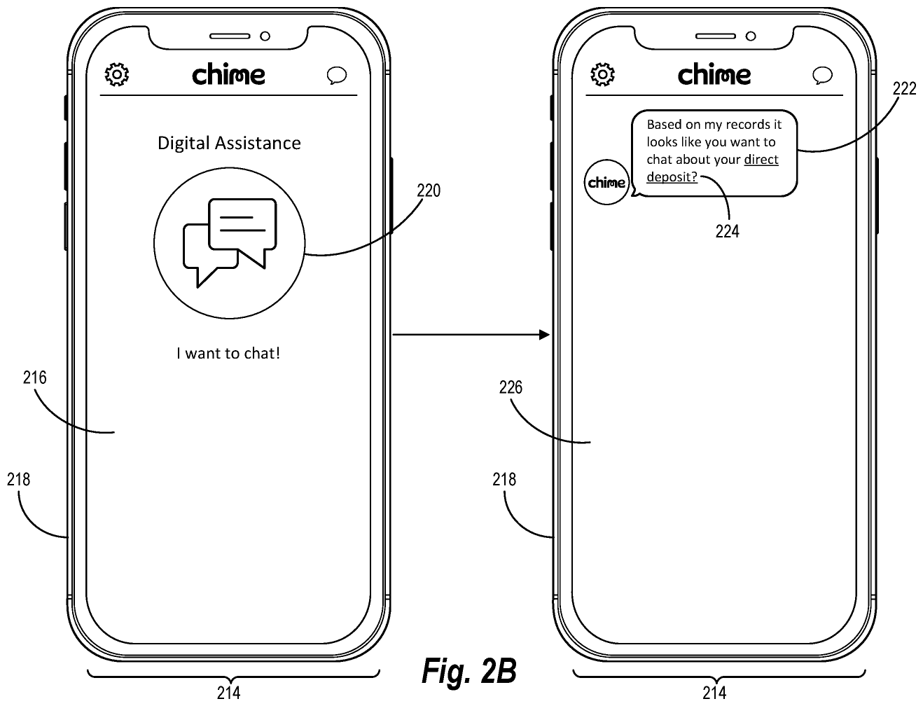

As discussed above, the automated client interaction system 102 can interact with the client device 108 to provide automated interaction responses using one or more machine learning models. For example, FIG. 2A illustrates an overview of the automated client interaction system 102 utilizing a machine learning model 202 to generate an automated interaction response 210 in accordance with one or more embodiments. More specifically, as illustrated in FIG. 2A, the automated client interaction system 102 extracts client features 200 corresponding to a client device 212 and uses the machine learning model 202 to generate a predicted client disposition classification 204 and a disposition classification probability 206. The automated client interaction system 102 utilizes the predicted client disposition classification 204, the disposition classification probability 206, and a disposition classification threshold 208 to generate and provide the automated interaction response 210.

As just mentioned, the automated client interaction system 102 extracts client features 200. For example, when the client device 212 contacts the automated client interaction system 102, the automated client interaction system 102 determines the identity of the client device 212 either through a device application 213 or through client provided credentials. In particular, client provided credentials can include social security numbers, caller ID, card numbers, personal identification numbers, and other information related to a digital account.

Upon determining a digital account or identity corresponding to the client device 212, the automated client interaction system 102 extracts the client features 200 corresponding to a digital account of the client device 212 or the device application 213. For example, the client features 200 can include previous interactions between the client device 212 and the automated client interaction system 102, a value metric of the digital account, an account status, or recent activity of the digital account. For example, the client features 200 can include the last balance, a maximum/minimum balance within a threshold time, a maximum/minimum transaction amount within a threshold time, a number of previous interactions, time since the last dispute update (e.g., a status update corresponding to a dispute), a fraud or risk score, and/or a number of previous interactions. The client features 200 can include calls, transactions, disputes, messages, account views, log ins, low balance events, authorizations, web contacts, account settings views, settlements, card activity, account creations, or home page views. The automated client interaction system 102 can extract the client features 200 from a variety of sources, including a digital account corresponding to a user, the client device 212, and/or a database of historical interactions or information pertinent to a user/client device. For instance, automated client interaction system 102 can extract the client features 200 from previous interactions with the client device 212 such as phone calls, online-chat sessions on the client device 212 or the client application 213, or user interactions with user interfaces of the device application 213.

Similarly, the automated client interaction system 102 can extract the client features 200 from a value metric such as an account balance for a digital account, the value of a direct deposit, the value of a transaction made on the digital account, the value of interest accrued on a digital account, or the value of fees owed. Moreover, the automated client interaction system 102 can extract the client features 200 from an account status such as whether an account is active, closed, temporarily disabled, on hold, or in default. Furthermore, the automated client interaction system 102 can extract the client features 200 from recent activity such as the client device 212 contacting the automated client interaction system 102 or entering an online-chat session within the last 5 hours. In addition, the client features 200 can include information regarding the client device, such as device type (e.g., smartphone or personal computer), operating system, or application version.

In one or more embodiments, the automated client interaction system 102 extracts the client features 200 by comparing historical events/features with current features. For example, the client features 200 can include the time that has passed since a previous event (e.g., time since a previous call, a previous transaction, a previous dispute, a previous message, a previous viewing of an account, a previous log in, a low balance event, a previous authorization, a previous web contact, a previous viewing of account settings, a previous settlement, a card was frozen/unfrozen, an account was created, or a home page was viewed). The automated client interaction system 102 can also extract other client features such as a transaction amount (over the last threshold period, such as 128 days), a number of views (e.g., a number of home views or spending account views within the last 128 days), or a range over mean balance within a threshold time period.

As illustrated in FIG. 2A, upon extracting client features 200, the automated client interaction system 102 utilizes the machine learning model 202 to generate predicted client disposition classifications and disposition classification probabilities. In particular, the automated client interaction system 102 utilizes the machine learning model 202 to analyze the client features 200. For example, the automated client interaction system 102 can encode the client features 200 (e.g., using one hot encoding, an encoding layer, or a vector mapping) and then process the encoding utilizing the machine learning model 202.

The automated client interaction system 102 can utilize a variety of machine learning models to analyze the client features 200. With regard to FIG. 2A, the machine learning model 202 is a decision tree, such as a random forest model or a boosted gradient decision tree. Accordingly, the automated client interaction system 102 feeds the client features 200 to input channels of the random forest model. The random forest model then utilizes learned nodes within one or more decision trees to generate a predicted classification and corresponding probability or likelihood. In other implementations the automated client interaction system 102 can utilize a neural network, such as a convolutional neural network, or other machine learning model to process the client features 200.

As shown in FIG. 2A, the automated client interaction system 102 utilizes the machine learning model 202 to generate the predicted client disposition classification 204. The predicted client disposition classification 204 can include a variety of dispositions or purposes for a client interaction. For example, the automated client interaction system 102 utilizes the machine learning model 202 to predict a client device initiating a client interaction (e.g., calling) to activate a card, request information regarding a recent deposit, inquire regarding a recent statement, open a new account, close an account, or some other disposition. Similarly, client disposition classifications can include an account update, direct deposit status (e.g., has an account received a direct deposit), fee information (e.g., information regarding one or more fees associated with the account), check status (e.g., whether or not a check has cleared an account), interaction history (e.g., information regarding recent transactions or other interactions), order status (e.g., status of a particular order or transaction), and activation (e.g., activation of an account, product, card, or service).

To illustrate, the automated client interaction system 102 can determine “fee information” (e.g., ATM fees) as the predicted client disposition classification 204 upon detecting features indicating that a fee recently applied to an account. Similarly, the automated client interaction system 102 can determine “check status” (e.g., check cancellation or check clearance) in response to detecting features indicating that a client recently submitted a check for deposit, has a check scheduled for payment, or has recently called regarding the status of a check. Similarly, the automated client interaction system 102 can identify “interaction history” as the predicted client disposition classification 204 upon determining client features showing that the digital account associated with the client device 212 recently made multiple high value transactions, recently had a declined transaction, or recently checked their interaction history on the device application 213. In addition, the automated client interaction system 102 can identify “order status” as the predicted client disposition classification 204 upon identifying client features showing that the digital account associated with the client device 108 recently ordered a card associated with a digital account. Further, the automated client interaction system 102 can select the category “activation” upon determined client features indicating the digital account associated with the client device 212 recently attempted to activate a digital account or card. Moreover, the automated client interaction system 102 can determines “dispute” as the predicted client disposition classification 204 in response client features indicating the client device 212 recently made a large purchase that does not fit the client device's 212 usual pattern of spending.

In addition to the predicted client disposition classification 204, the machine learning model 202 also generates the disposition classification probability 206. The disposition classification probability 206 reflects the likelihood that the predicted client disposition classification 204 corresponds to the actual disposition of the client. Thus, if the automated client interaction system 102 predicts “direct deposit status” as the client device's disposition, the automated client interaction system also generates a corresponding probability (e.g. 85%) as a level of confidence for the actual reason of contact.

In some embodiments, the automated client interaction system 102 generates a plurality of predicted client disposition classifications and corresponding disposition classification probabilities. For example, the automated client interaction system 102 can utilize the machine learning model 202 to generate multiple predicted client disposition classifications with a corresponding probability distribution for the predicted classifications.

Moreover, as shown in FIG. 2A, the automated client interaction system 102 also identifies and utilizes the disposition classification threshold 208. In particular, the automated client interaction system 102 can utilize the disposition classification threshold 208 to select one or more client dispositions and then generate the automated interaction response 210. To illustrate, the automated client interaction system 102 can determine the disposition classification threshold 208 of 85%. The automated client interaction system 102 can then compare disposition classification probabilities (i.e., the disposition classification probability 206) with the disposition classification threshold 208. Thus, if the automated client interaction system 102 determines that the disposition classification probability 206 (e.g., 86%) satisfies the disposition classification threshold 208 (e.g., 85%) the automated client interaction system 102 can take a first course of action (e.g., generate the automated interaction response 210). If the automated client interaction system 102 determines that the disposition classification probability 206 (e.g., 50%) does not satisfy the disposition classification threshold 208 (e.g., 85%) the automated client interaction system 102 can take a second course of action (e.g., withhold an automated interaction response).

In some implementations, the automated client interaction system 102 utilizes the predicted client disposition classification with the maximum probability. In some embodiments, the automated client interaction system 102 uses the predicted client disposition classification that is the maximum probability so long as the probability is greater than a 0.5 disposition classification threshold. Moreover, in one or more embodiments, the automated client interaction system 102 utilizes the predicted client disposition classification that is the maximum probability so long as the probability is greater than a 0.6 disposition classification threshold.

The automated client interaction system 102 can determine the disposition classification threshold 208 in a variety of ways. For example, in some implementations the automated client interaction system 102 determines the disposition classification threshold 208 based on user input (e.g., a user interaction selecting a particular threshold). In other embodiments, the automated client interaction system 102 determines the disposition classification threshold 208 based on historical user interactions with automated interaction responses. For example, the automated client interaction system 102 can determine an amount of time or computer resources to interact with automated interaction responses that are accurate and/or inaccurate. The automated client interaction system 102 can then determine the disposition classification threshold 208 to improve (e.g., optimize) the time and/or computer resources for responding to client devices.

To illustrate, the automated client interaction system 102 can determine that it takes an extra 15 seconds (and corresponding computer resources) to respond to an automated interaction response. The automated client interaction system 102 can also determine a corresponding improvement in time/computer resources resulting from an accurate automated interaction response that allows the client device to bypass conventional interface or call options/menus. The automated client interaction system 102 can utilize a function (e.g., an objective/optimization function) to solve for a probability that will reduce (e.g., minimize) the total expected amount of time and computing resources to respond to client devices. Indeed, if the automated client interaction system 102 sets the threshold too high, the automated client interaction system 102 could fail to provide an automated interaction response in most instances. Conversely, if the automated client interaction system 102 sets the threshold too low, the automated client interaction system 102 could introduce wasted time and resources by providing too many inaccurate automated interaction responses. The automated client interaction system 102 can intelligently balance these factors to improve the efficiency of implementing devices.

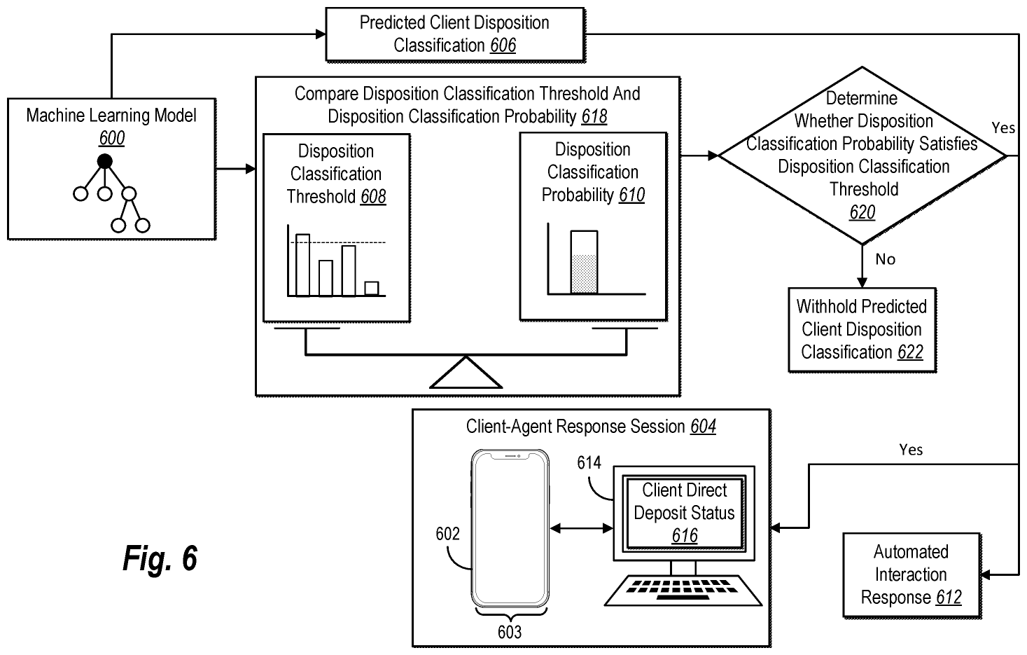

In some embodiments, the automated client interaction system 102 does not utilize the disposition classification threshold 208. For example, the automated client interaction system 102 can utilize a predicted client disposition classification with a highest disposition classification probability 206 to generate the automated interaction response 210. In other instances, the disposition classification threshold varies. Additional detail regarding the disposition classification threshold is provided below (e.g., in relation to FIG. 6).

As illustrated in FIG. 2A, the automated client interaction system 102 provides an automated interaction response 210. For example, the automated client interaction system 102 generates the automated interaction response 210 based on the disposition classification threshold 208, the disposition classification probability 206, and the predicted client disposition classification 204. As discussed above, the predicted client disposition classification 204 has the corresponding disposition classification probability 206. In particular, if the disposition classification probability 206 satisfies the disposition classification threshold 208 then the automated client interaction system 102 generates the automated interaction response 210. The automated client interaction system 102 then provides the automated interaction response 210 to the client device 212.

As mentioned above, in some embodiments the automated client interaction system 102 generates an automated interaction response that includes an indicator of a predicted client disposition classification. For example, in FIG. 2B the automated client interaction system 102 determines direct deposit status as the predicted client disposition classification 204 and determines that the corresponding disposition classification probability 206 satisfies the disposition classification threshold 208. In response, the automated client interaction system 102 generates an automated interaction response 222 that include an indicator 224 of the predicted client disposition classification 204 based on the disposition classification probability 206 and the disposition classification threshold 208.

For example, as shown in FIG. 2B, a client device 218 displays a graphical user interface 216 of a device application 214. The client device 218 illustrates the graphical user interface 216 which includes user interface elements allowing a user to request digital assistance. In particular, the graphical user interface 216 includes a query element 220. In response to user interaction with the query element 220, the client device 218 initiates a client query to the automated client interaction system 102. In particular, in response to user selection of the query element 220, the device application 214 displays an additional graphical user interface 226 that includes the automated interaction response 222. As described above, the automated interaction response 222 is based on the predicted client disposition classification 204. The automated interaction response 222 includes the indicator 224 of the predicted client disposition classification 204 (e.g., the indicator 224 “direct deposit” within the text, “based on my records it looks like you want to chat about your direct deposit?”).

In some embodiments, the automated interaction response 222 includes a statement asking the client device 218 to confirm the predicted client disposition classification 204. For example, if the corresponding disposition classification probability 206 satisfies the disposition classification threshold 208 (but does not satisfy a second disposition classification threshold), the automated client interaction system 102 can generate the automated interaction response 222 to include a confirmation option, such as, “based on our records it looks like you're contacting us about your direct deposit status, if this is correct, we can transfer you directly to an agent.”

Moreover, in another example embodiment, selecting the query element 220 initiates a phone call session between the client device 218 and the automated client interaction system 102. For example, the client device selects the query element 220 and subsequently the client device 218 displays the additional graphical user interface 226 that includes an option to “chat via text” or to “initiate a phone call session.” The automated client interaction system 102 can generate and provide the automated interaction response 222 as an oral automated interaction response (interactive voice response) within the phone call session.

Although FIGS. 2A-2B illustrate a particular set of acts and interfaces (in particular orders), in some embodiments the automated client interaction system 102 performs a different number of acts and/or a different order of acts. For example, in some embodiments the automated client interaction system 102 extracts client features 200 in response to receiving a client query (not shown in FIG. 2A). The client query can occur when the client device 212 contacts the automated client interaction system 102 (e.g., a client query can be a client device that calls and connects to the automated client interaction system 102). Similarly, the client query can occur when a client poses a question or makes a statement. In response, the automated client interaction system 102 identifies the client query made by the client device 212. After identifying the client query, the automated client interaction system 102 extracts corresponding client features 200 from the digital account and utilizes it in the machine learning model 202, as shown in FIG. 2A. In particular, the client query can include a question of “where is my direct deposit?” or the client query can include a statement of “most recent withdrawal.”

As an example of the client query discussed above, the client device 212 directly poses their question to the automated client interaction system 102. Even if the client device 212 directly poses questions, the automated client interaction system 102 can still utilize the client features 200 and machine learning model 202.

For instance, the automated client interaction system 102 responds to questions from the client device 212 by utilizing the machine learning model 202 to generate the predicted client disposition classification 204, the disposition classification probability 206 and the disposition classification threshold 208. Indeed, the client features 200 can also include text or audio of a particular question provided by the client device 212.

In some implementations, the automated client interaction system 102 can prompt the client device 212 to provide a text or audio input describing a purpose for an interaction. The automated client interaction system 102 can generate such a prompt based on a variety of factors. For instance, in some embodiments, the automated client interaction system 102 asks the client to provide a statement regarding the purpose of a call if the disposition classification probability 206 fails to satisfy the disposition classification threshold 208. In some embodiments, the automated client interaction system 102 prompts the client device 212 to provide a statement based on time (e.g., based on the time since the last interaction between the client device and the automated client interaction system 102).

In one or more implementations, the automated client interaction system 102 determines that the predicted client disposition classification 204 provided does not align with the actual disposition of the digital account or the client device 212. For example, if the automated client interaction system 102 provides the automated interaction response 210 and the client device 212 provides a user interaction indicating an incorrect predicted client disposition classification 204, then the automated client interaction system 102 can initiate an alternate set of acts (e.g., initiate a client-agent response session, present a pre-defined list of menu options, or present a list of menu options particular to a second predicted client disposition classification).

The automated client interaction system can present such a pre-defined or standardized list of menu options upon determining that no predicted client disposition classifications satisfy a disposition classification threshold. In such circumstances, the automated client interaction system 102 can provide the client device 212 with a list of menu options (but without the automated interaction response 210). In particular, the automated client interaction system 102 can provide a list of menu options to allow the client device 212 to select how to proceed with the interaction (e.g., with a sub-list of menu options follows a list of menu options). In some embodiments, the automated client interaction system 102 will utilize the machine learning model 202 after the client device 212 has responded to a first set of options, determine whether a predicted disposition classification satisfies a disposition classification threshold, and then provide the automated interaction response 210.

While FIGS. 2A-2B illustrate the automated client interaction system 102 providing the automated interaction response 210 a single time, in certain example embodiments, the automated client interaction system 102 provides the predicted client disposition classification 204 to the client device 108 repeatedly through multiple automated interaction responses. For example, if the automated client interaction system 102 provides the predicted client disposition classification 204 in the automated interaction response 210 and the client device 212 fails to confirm or deny, the automated client interaction system 102 presents an additional automated interaction response to the client device 212 that reflects the predicted client disposition classification 204.

In some implementations, the automated client interaction system 102 provides the predicted client disposition classification 204 within a threshold period of time (e.g., 3-60 seconds) after the client device 212 contacts the automated client interaction system 102. For example, in a circumstance where the client device 212 is authenticated within two seconds, the predicted client disposition classification 204 is provided within 3-5 seconds. In certain example embodiments, if the automated client interaction system 102 is unable to generate the predicted client disposition classification 204 within a threshold time frame, the automated client interaction system 102 presents a list of menu options for the client device 108 (rather than an automated interaction response that includes a predicted client disposition classification).

Although FIG. 2B illustrates the automated client interaction system 102 providing the automated interaction response 222 immediately (e.g., without any intervening options or interactions), the automated client interaction system 102 can provide the automated interaction response 222 at different times and/or within a sequence of other responses. For example, in some implementations, the automated client interaction system 102 provides menu options to a client (e.g., as part of a call) while the automated client interaction system 102 determines a predicted client disposition classification. Upon identifying the predicted client disposition classification, the automated client interaction system 102 can provide an automated interaction response at an identified point (e.g., a junction point) within a pre-defined set of menu options.

In some embodiments, the automated client interaction system 102 generates predicted client disposition classifications utilizing a particular time schedule or frequency. For example, in one or more embodiments, the automated client interaction system 102 generates a predicted client disposition classification for digital accounts every hour. For example, even when the client device 108 has not contacted the automated client interaction system 102, the automated client interaction system 102 generates predicted client disposition classification 204 for the client device 212. In particular, this example embodiment allows for the automated client interaction system 102 to present the prediction to the client device 212 immediately upon contact.

As shown in FIG. 2A, the automated client interaction system 102 utilizes the machine learning model 202. However, in some embodiments, the automated client interaction system 102 uses a heuristic model in tandem with the machine learning model 202 to generate the predicted client disposition classification 204. For example, if the client device 212 has contacted the automated client interaction system 102 ten times in a day for the same reason, then if the client device 212 contacts the automated client interaction system 102 for the eleventh time that day, the automated client interaction system 102 can utilize the heuristic model to determine the client disposition. Or if the client device 212 unsuccessfully signs into the device application 213, the heuristic model can apply one or more rules to determine the predict client disposition corresponds to the unsuccessful login.

To illustrate, the heuristic model could include certain rules that take precedence over the predictions generated by the machine learning model 202, or vice-versa. In particular, the rule-based prediction can use application programming interfaces (APIs) to retrieve client features 200 from a third-party server. Based on the retrieved client features 200, the automated client interaction system 102 determines whether to give priority to the rule-based model or the machine learning model.

In certain example embodiments, the automated client interaction system 102 also utilizes a time threshold for analyzing client features corresponding to a client device. For example, in applying a heuristic model, the automated client interaction system 102 can utilize a time threshold of one day. In such a circumstance, the automated client interaction system 102 can analyze the client features 200 that reflect user activity within the previous day, but ignore the client features 200 that exceed the one-day threshold. Moreover, if the client features 200 all reflect user information outside of the time threshold, then the automated client interaction system 102 can refrain from generating a prediction utilizing the heuristic model.

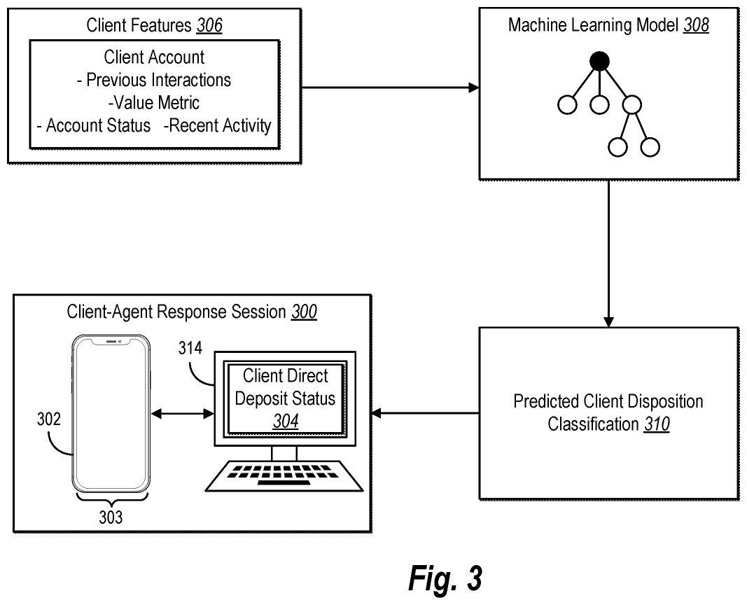

As discussed above, in some implementations the automated client interaction system 102 initiates a client-agent response session. FIG. 3 illustrates an overview of the automated client interaction system 102 initiating a client-agent response session 300 with a client device 302 and device application 303.

Specifically, FIG. 3 illustrates the automated client interaction system 102 extracts client features 306 corresponding to the client device 302 (as described above with regard to FIG. 2A). Similarly, a machine learning model 308 generates a predicted client disposition classification 310 (and corresponding disposition classification probabilities) based on the client features 306. Indeed, the automated client interaction system 102 generates the predicted client disposition classification 310 (and corresponding probabilities) for display on an agent device 314 with an indicator 304 of the predicted client disposition classification 310.

As shown in FIG. 3, the automated client interaction system 102 also initiates the client-agent response session 300. In particular, the automated client interaction system 102 initiates an audio conversation (e.g., telephone or digital audio conversation) or a live chat session between the agent device 314 and the client device 108. Accordingly, the agent device 314 can directly assist the client device 302 in identifying pertinent information or resources.

In some embodiments, the automated client interaction system 102 automatically selects and implements a workflow at the agent device 314 (e.g., a prompt, sequence of actions to take, or series of operations) based on the predicted client disposition classification. For example, if the automated client interaction system 102 predicts that a client seeks to open an account, the automated client interaction system 102 can present a workflow at the agent device 314 to assist the client in opening an account.

The automated client interaction system 102 can initiate the client-agent response session 300 in response to a variety of triggers. For example, the automated client interaction system 102 can initiate the client-agent response session 300 in response to the client device 302 confirming the predicted client disposition classification 310. The automated client interaction system 102 can also initiate the client-agent response session 300 due to the disposition classification probability 206 satisfying the disposition classification threshold 208 or a second disposition classification threshold. As discussed in greater detail below (e.g. in relation to FIG. 6), the automated client interaction system 102 can apply a variety of different disposition classification thresholds to trigger different events.

The automated client interaction system 102 can also initiate the client-agent response session 300 in response to determining that multiple predicted client disposition classifications satisfy the disposition classification threshold 208. Similarly, the automated client interaction system 102 can initiate the client-agent response session 300 in response to detecting that the client device 302 fails to confirm the predicted client disposition classification 310.

In addition, the automated client interaction system 102 can initiate the client-agent response session 300 in response to detecting a high-urgency classification. For example, the automated client interaction system 102 identifies a subset of client disposition classifications as high-urgency classifications. In response to the automated client interaction system 102 identifying a high-urgency classification, the automated client interaction system 102 can trigger the client-agent response session 300. For instance, if the automated client interaction system 102 designates “activation” as a high-urgency classification and the automated client interaction system 102 classifies the client device 302 as “activation,” then the automated client interaction system 102 initiates the client-agent response session 300.

In some implementations, the automated client interaction system 102 immediately escalates an interaction to the client-agent response session 300 (e.g., in response to detecting use of certain key words). Alternatively, in another example embodiment, the automated client interaction system 102 immediately escalates the interaction to the client-agent response session 300 but extracts client features 306, utilizes the machine learning model 308, and generates the predicted client disposition classification 310. During the client-agent response session 300, the automated client interaction system 102 can provide the generated prediction to the agent device 314.

In one or more embodiments, the client device 302 confirms initiation of a session. In particular, prior to initiating the client-agent response session 300 the automated client interaction system 102 prompts the client device 302 regarding the possibility of escalating to the client-agent response session 300. If the client device 302 declines the client-agent response session 300, the automated client interaction system 102 provides the automated interaction response 210, terminates the call, or presents a list of menu options for selection.

Moreover, in one or more embodiments the automated client interaction system 102 does not initiate the client-agent response session 300. For example, the automated client interaction system 102 can determine that there are no predicted client disposition classifications for the client device 302. In this situation, the automated client interaction system 102 can initiate a list of menu options to narrow down the reason for contact. In particular, the automated client interaction system 102 can also present a sub-menu of options after the list of menu options to further narrow down the reason for contact. Similarly, the automated client interaction system 102 can determine that none of the generated predicted client disposition classifications satisfy the disposition classification threshold 208. This can cause the automated client interaction system to also present a list of menu options with subsequent sub-menu options (and not initiate the client-agent response session 300).

As mentioned above, the agent device 314 can display the predicted client disposition classification 204. The agent device 314 can utilize the predicted client disposition classifications in a variety of ways. For example, the automated client interaction system 102 provides the predicted client disposition classification 310 directly to the agent device 314. This allows the agent device 314 to know what the automated client interaction system 102 deems the reason for contact. The agent device 314 can utilize this predicted client disposition classification 310 to assist the client device 302.

The agent device 314 can also receive multiple predicted client disposition classifications from the automated client interaction system 102. For example, the automated client interaction system 102 generates multiple predicted client disposition classifications for the client device 302. In response to initiation of the client-agent response session 300, the automated client interaction system 102 provides the multiple predicted client disposition classifications to the agent device 314. The agent device 314 can utilize the multiple predicted client disposition classifications to determine one of many reasons for contact. In particular, the automated client interaction system 102 can provide the agent device 314 multiple predicted client disposition classifications in rank-order, based on highest disposition classification probability 206 to lowest.

Furthermore, the automated client interaction system 102 provides the probability along with the predicted client disposition classification 310. For example, if the automated client interaction system 102 determines “direct deposit status” as the predicted client disposition classification 310 with the corresponding disposition classification probability 206 of 85%, the automated client interaction system provides both the predicted client disposition classification 310 and the disposition classification probability 206. In particular, the provided probability allows the agent device 314 to assess the confidence of the provided predicted client disposition classification 204. Additionally, in the situation where the automated client interaction system 102 generates multiple predicted client disposition classifications with multiple disposition classification probabilities, the automated client interaction system 102 can provide all of these to the agent device 314. In particular, the automated client interaction system 102 can provide multiple classifications and probabilities to the agent device 314 in order of highest to lowest with each classification listed with its corresponding probability. This allows the agent device 314 to assess multiple predicted classifications along with the automated client interaction system's 102 confidence level for each prediction.

In other circumstances, the automated client interaction system 102 provides the predicted client disposition classification 310 confirmed by the client device 302 to the agent device 314. For example, the automated client interaction system 102 presents the predicted client disposition classification 310 to the client device 302 and in response to the client device 302 confirming the prediction as correct, the automated client interaction system 102 provides the prediction to the agent device 314.

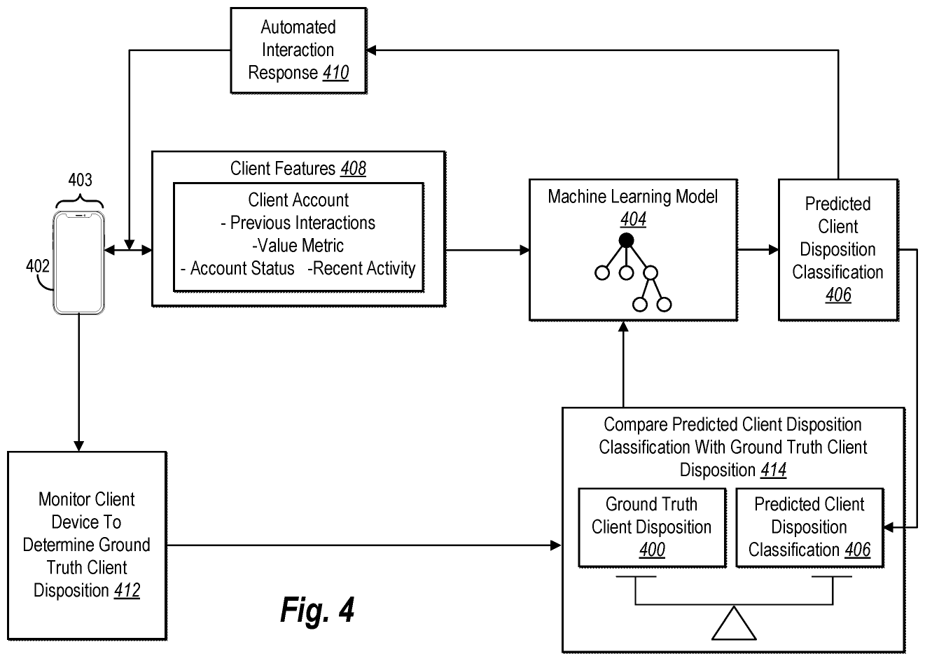

As discussed above, the client device 212 can train the machine learning model 202 for predicting disposition classifications. For example, FIG. 4 illustrates an overview of monitoring a client device 402 with device application 403 to determine a ground truth client disposition 400 and train a machine learning model 404.

As illustrated in FIG. 4, the automated client interaction system 102 extracts client features 408 that correspond with the client device 402 and utilizes the machine learning model 404 to generate a predicted client disposition classification 406. In response, the automated client interaction system 102 generates an automated interaction response 410 and provides the automated interaction response 410 to the client device 402.

As shown, the automated client interaction system 102 performs an act 412 of monitoring interactions with the client device 402 to determine the accuracy of the predicted client disposition classification 406. For example, the client device 402 can provide a user interaction confirming (or denying) the accuracy of the predicted client disposition classification 406. Similarly, the automated client interaction system 102 can monitor additional user interactions, such as information ultimately provided to the client device 402 or information requested from an agent device. The automated client interaction system 102 can determine the ground truth disposition from these interactions. Accordingly, the automated client interaction system 102 monitors the client device 402 (and/or agent device interactions) to determine ground truth client dispositions.

As mentioned, the automated client interaction system 102 can further train the machine learning model 404 based on the ground truth client disposition 400. For example, the automated client interaction system 102 performs an act 414 of comparing the predicted client disposition classification 406 with the monitored ground truth client disposition 400. In particular the automated client interaction system 102 compares the predicted client disposition classification 406 and the ground truth client disposition 400 with a loss function. A loss function can determine a measure of loss between the predicted client disposition classification 406 and the ground truth client disposition 400. The loss function can include mean absolute error (L1) loss functions, mean squared error (L2) loss functions, cross entropy loss functions, or Kullback-Leibler loss.

The automated client interaction system 102 trains the machine learning model 404 based on the comparison between the predicted client disposition classification 406 and the ground truth client disposition 400. For example, the automated client interaction system 102 can modify nodes of a decision tree model (e.g., a random forest model) based on the measure of loss from the loss function. Similarly, the automated client interaction system 102 can modify internal weights or parameters of a neural network (e.g., via back propagation) to reduce the measure of loss. On subsequent interactions between client devices and the automated client interaction system 102, the machine learning model 404 provides improved predicted client disposition classifications.

Upon training, the automated client interaction system 102 can utilize the machine learning model 404 to further generate predicted client disposition classifications. For example, in some embodiments, the automated client interaction system 102 generates batch predictions for a population of clients at a certain frequency (e.g., every hour) even if the clients have not provided a client query (e.g., have not initiated a call or text session).

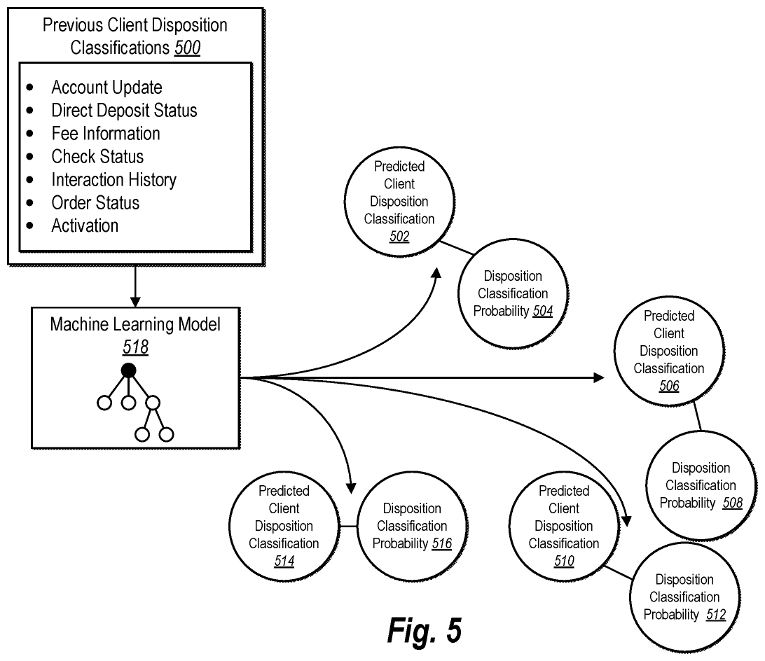

As discussed above, the automated client interaction system 102 generates predicted client disposition classifications and disposition classification probabilities based on previous client disposition classifications. FIG. 5 illustrates determining previous client disposition classifications 500 and using a machine learning model 518 to generate additional predicted client disposition classifications.

As illustrated in FIG. 5, the automated client interaction system 102 determines previous client disposition classifications 500 (e.g., previous classifications determined utilizing the machine learning model 202 or determined based on additional interactions monitored at the client device). For example, the previous client disposition classifications 500 includes digital account updates, direct deposit status, device fee information, check status, interaction history, order status, disputes, and activation. In particular, the automated client interaction system 102 uses the previous client disposition classifications 500 in the machine learning model 518. The machine learning model 518 uses the previous client disposition classifications 500 to generate predicted client disposition classifications for the digital account or the client device 402 and the corresponding disposition classification probability 206 (shown in FIG. 2A) of the prediction.

In an example embodiment, the automated client interaction system 102 predicts “direct deposit status” as the predicted client disposition classification 502 for the digital account or the client device 402. In particular, the automated client interaction system 102 extracts the client features 200 and determines that the client device 212 previously called regarding several deposits within the past month. The machine learning model 518 can utilize this prior information to determine that the previously predicted client disposition classification corresponds to a direct deposit status (or another classification that the machine learning model 518 has identified as correlating to direct deposit queries). The automated client interaction system 102 can utilize this previous client disposition classification with the machine learning model 518 to determine the predicted client disposition classification (e.g., the predicted client disposition classifications 502-514).

FIG. 5 shows example categories of the previous client disposition classifications 500. The automated client interaction system 102 can utilize these previous client disposition classifications (in isolation or in combination) to generate a predicted client disposition classification. For example, the automated client interaction system 102 can determine that a client device previously called regarding a check status (in a first call) and then called regarding interaction history (in a second call). The machine learning model can identify learned patterns between these previous client disposition classifications (and other client features) and predict (for example) that a client device is calling regarding an account update. Thus, the automated client interaction system 102 utilizes the previous client disposition classifications 500 to generate new predicted client disposition classifications 502, 506, 510, and 514 and corresponding new disposition classification probability 504, 508, 512, and 516.

As discussed above, the automated client interaction system 102 generates automated interaction responses from predicted client disposition classifications, disposition classification probabilities, and disposition classification thresholds. FIG. 6 illustrates an overview of the automated client interaction system 102 comparing client disposition classifications and disposition classification probabilities to determine whether to withhold or provide automated interaction responses. As illustrated in FIG. 6, the automated client interaction system 102 uses a machine learning model 600 to generate a predicted client disposition classification 606 and a disposition classification probability 610. For example, the automated client interaction system 102 performs an act 618 of comparing the disposition classification threshold 608 with the disposition classification probability 610. Moreover, the automated client interaction system 102 performs an act 620 of determining whether the disposition classification probability satisfies the disposition classification threshold. In particular, if the automated client interaction system 102 determines that the disposition classification probability 610 satisfies the disposition classification threshold 608 then the automated client interaction system 102 provides an automated interaction response 612 to the client device 108. If not, the automated client interaction system 102 performs an act 622 of withhold the predicted client disposition classification.

As illustrated, in some circumstances, in response to determining that the disposition classification probability 610 satisfies the disposition classification threshold 608, the automated client interaction system 102 initiates a client-agent response session 604. As discussed above, in some implementations, the client-agent response session 604 (e.g., the client-agent response session 300 of FIG. 3) includes providing an indicator 616 of the predicted client disposition classification 606 via an agent device 614.

Although FIG. 6 illustrates the disposition classification threshold 608 as a single threshold, the automated client interaction system 102 can utilize a variety of different thresholds to intelligently performance a variety of different acts with regard to the automated interaction response 612 and the client-agent response session 604. For example, the automated client interaction system 102 can apply a first disposition classification threshold to determine whether to provide the automated interaction response 612 (e.g., a response with an indicator of the predicted client disposition classification 606). If the automated client interaction system 102 determines that the disposition classification probability satisfies the first disposition classification threshold, the automated client interaction system 102 provides the automated interaction response 612. As illustrated, the automated client interaction system 102 can withhold the predicted client disposition classification 606 upon determining the first disposition classification threshold is not satisfied.

As mentioned above, the automated client interaction system 102 can also apply a second disposition classification threshold to determine whether to initiate the client-agent response session. In some implementations, if the automated client interaction system 102 determines that the disposition classification probability satisfies the second disposition classification threshold, the automated client interaction system initiates the client-agent response session (e.g., without providing the automated interaction response 612). The automated client interaction system 102 can also apply a third disposition classification threshold to determine whether or not to provide a predicted client disposition classification for display via the agent device 614. In some embodiments, the automated client interaction system 102 applies a fourth disposition classification threshold to determine whether to provide an automated response asking the user to confirm the predicted client disposition classification and/or to confirm if the client would like to initiate the client-agent response session 604.

In some implementations, the automated client interaction system 102 can apply a fifth threshold to determine whether to automatically provide responsive information that addresses the predicted client disposition classification 606. For example, the automated client interaction system 102 can determine a predicted client disposition classification 606 that indicates a client seeks information regarding an account balance. Upon determining that the corresponding disposition classification probability satisfies the fifth disposition classification threshold, the automated client interaction system 102 can automatically provide the user's account balance (e.g., before the user even asks to see the account balance or confirms the predicted client disposition classification). The automated client interaction system 102 can also determine multiple predicted client disposition classifications with multiple corresponding disposition classification probabilities that satisfy the disposition classification threshold 608. Because multiple disposition classification probabilities can satisfy the various disposition classification thresholds, the automated client interaction system 102 can initiate different responses for different client disposition classifications. For instance, the automated client interaction system 102 can generate an automated interaction response 612 that indicates multiple predicted client disposition classifications (where the corresponding disposition classification probabilities satisfy a disposition classification threshold). Similarly, the automated client interaction system 102 can initiate a client-agent response session 604 and provide multiple predicted client disposition classifications for display via the agent device 614 (if multiple disposition classification probabilities satisfy a particular disposition classification threshold). In some circumstances, the automated client interaction system 102 can automatically provide responsive information for a first predicted client disposition classification (e.g., automatically provide an account balance) and also provide an additional automated interaction response that includes a request to confirm a second predicted client disposition classification (e.g., request that the client confirm that they would also like to inquire about a direct deposit status).

As just mentioned, the automated client interaction system 102 can utilizes different disposition classification threshold 608 at different levels to perform different actions. For example, the automated client interaction system 102 can initiate the client-agent response session in response to the satisfaction of a high confidence threshold. For example, the automated client interaction system 102 can set the disposition classification threshold 608 for the initiation of the client-agent response session 604 at a high confidence level such as 80%. A high confidence threshold causes the automated client interaction system 102 to immediately trigger the client-agent response session 604.

Similarly, the automated client interaction system 102 can set an intermediate confidence level for sending a confirmation message. If the disposition classification probability 610 satisfies this intermediate level of confidence, the automated client interaction system 102 can provide the automated interaction response 612 for confirmation. In particular, the automated client interaction system 102 provides “direct deposit status” as the predicted client disposition classification 606 with a 0.52 disposition classification probability 610 to the client device 602. The automated client interaction system 102 receives an affirmative confirmation regarding “direct deposit status” from the client device 602. The automated client interaction system 102 can then initiate the client-agent response session 604 to provide the direct deposit status.

In addition, the automated client interaction system 102 can set a low confidence level for surfacing predicted client disposition classifications via the agent device 614 upon initiating the client-agent response session 604. For example, the automated client interaction system 102 can display any disposition classification above a 0.25 confidence level on the agent device 614.

In some embodiments, the automated client interaction system 102 initiates the client-agent response session 604 due to multiple generated predicted client disposition classifications. For example, the automated client interaction system 102 determines that the multiple predicted client disposition classifications exceed the disposition classification threshold 608 and instead of asking the client device 602 for confirmation, the automated client interaction system 102 initiates the client-agent response session 604. The initiation of the client-agent response session 604 in this situation allows the agent device 614 to determine the actual reason for contact.

In some embodiments, the automated client interaction system 102 can initiate the client-agent response session upon detecting that a client fails confirm the predicted client disposition classification 606. For example, if the automated client interaction system 102 needs to confirm the predicted client disposition classification 606 and the client device 602 fails to provide a confirmation after a pre-established time, then the automated client interaction system 102 can initiate the client-agent response session. In particular, this example allows the automated client interaction system 102 to expedite the process of assisting the client device 602.

In the circumstance where the disposition classification probability 610 does not satisfy the disposition classification threshold 608, the automated client interaction system 102 withholds the indicator 616 of the predicted client disposition classification 606. For example, if the predicted client disposition classification 606 has 0.45 for the disposition classification probability 610 and 0.65 for the disposition classification threshold 608, then the automated client interaction system 102 can provide a pre-defined response without the indicator 616 of the predicted client disposition classification 606 or revert to a list of menu options.

Although FIG. 6 illustrates a particular order for the acts described, the automated client interaction system 102 can utilize alternative acts or a different order. For example, in some implementations, the disposition classification threshold 208 utilizes a freshness threshold. In such an embodiment, the automated client interaction system 102 only utilizes predicted client disposition classifications that fall within a threshold period of time. For example, in applying a freshness threshold of 5 hours, the automated client interaction system 102 will not surface or provide a predicted client disposition classification that was generated six hours earlier. The automated client interaction system 102 can utilize a variety of freshness thresholds (e.g., 10 seconds, one minute, five hours, ten hours, 1 day, 1 week, or one month).

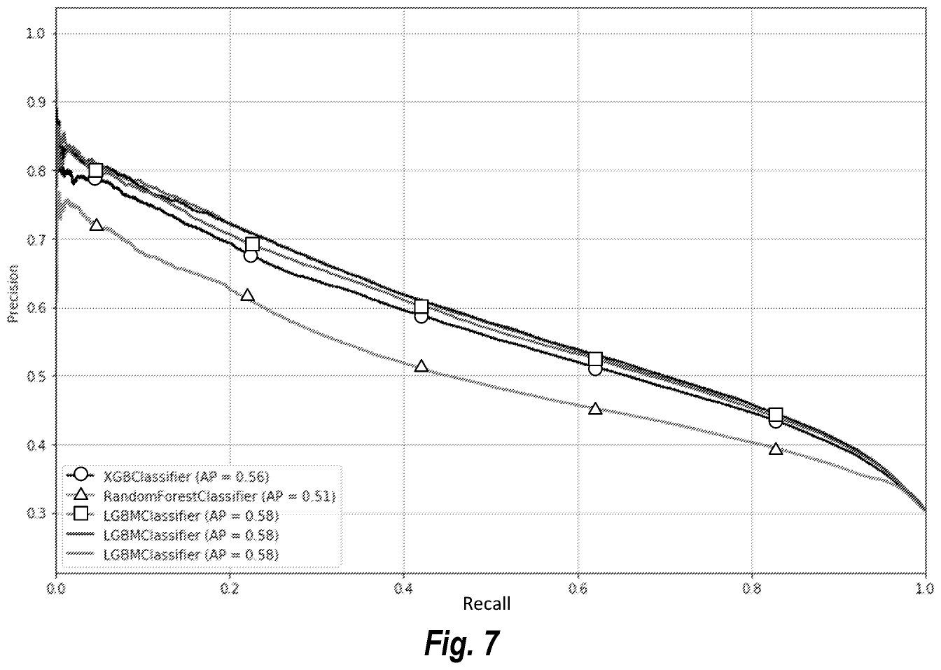

As mentioned above, the automated client interaction system 102 can improve accuracy relative to conventional systems. Experimenters have conducted an analysis of different machine learning models to demonstrate accuracy of predicted client dispositions. For example, FIG. 7 illustrates a precision-recall curve of different machine learning models utilized to generate predicted dispositions in accordance with one or more embodiments. In particular, FIG. 7 illustrates a precision recall curve utilizing XGBoost classifier, a random forest classifier, and three different variations on a LightGBM model. Specifically, the LightGBM model was implemented without variation, using a grid-search for hyperparameter tuning, and using a reduced feature set by keeping the top 30% of the most significant features. As illustrated, the LightGBM implementation had the best performance (and the reduced feature set performed similarly to the full set of features).

In some embodiments, the automated client interaction system 102 utilizes different machine learning models or different combinations of machine learning models. For example, in some implementations the automated client interaction system 102 utilizes a first machine learning model trained to identify transactions/disputes and a second machine learning model trained to identify deposits. In other implementations, the automated client interaction system 102 utilizes a multiclass machine learning model. The automated client interaction system 102 can also train different machine learning models for different interaction protocols. For example, the automated client interaction system 102 can train a first model to handle voice interactions (e.g., phone calls) and a second model to handle text threads (e.g., a chat bot or chat thread).

To illustrate, in some embodiments, the automated client interaction system 102 uses individual models for different classes and then combines the models. For example, the automated client interaction system 102 can use the class with the highest score (if greater than 0.5). Similarly, the automated client interaction system 102 can utilize other classes if scores are less than 0.5. In some implementations the automated client interaction system 102 utilizes a “one v rest” approach that compares each class with one other class (to get a probability for each class) and then combines the results (e.g., chooses the max result). In some embodiments, the automated client interaction system 102 utilizes a “one v one” approach that builds individual models that compare each class to one “other” class and then combines the results.

FIGS. 1-7, the corresponding text, and the examples provide a number of different systems, methods, and non-transitory computer readable media for selecting and providing a transportation request to a limited-eligibility provider device. In addition to the foregoing, embodiments can also be described in terms of flowcharts comprising acts for accomplishing a particular result. For example, FIG. 8 illustrates a flowchart of an example sequence of acts in accordance with one or more embodiments.

While FIG. 8 illustrates acts according to some embodiments, alternative embodiments may omit, add to, reorder, and/or modify any of the acts shown in FIG. 8. The acts of FIG. 8 can be performed as part of a method. Alternatively, a non-transitory computer readable medium can comprise instructions, that when executed by one or more processors, cause a computing device to perform the acts of FIG. 8. In still further embodiments, a system can perform the acts of FIG. 8. Additionally, the acts described herein may be repeated or performed in parallel with one another or in parallel with different instances of the same or other similar acts.

FIG. 8 illustrates an example series of acts 800 for facilitating an automated interaction response via an automated client interaction system. The series of acts 800 can include an act 802 of extracting client features corresponding to a client of the automated client interaction system. In some implementations, the act 802 occurs in response to a client query. Further, the act 802 can include determining a previous disposition. In particular, the act 802 can involve determining a previous disposition from a previous interaction by the client with the automated client interaction system and generating the predicted client disposition classification and the disposition classification probability from the previous disposition utilizing the machine learning model. Additionally, the act 802 of extracting account details can include determining a digital account duration, a direct deposit status of a digital account, or application device activity on the digital account.

As shown, the series of acts 800 can also include an act 804 of generating, utilizing a machine learning model, a predicted client disposition classification and a disposition classification probability. In particular, the act 804 can involve generating, utilizing a machine learning model, a predicted client disposition classification and a disposition classification probability from the client features.

Further, the act 804 can include further training of the machine learning model. In particular, the act 804 can involve monitoring client interaction with the automated client interaction system to determine a ground truth client disposition and training the machine learning model by comparing the predicted client disposition classification and the ground truth client disposition.

In addition, the act 804 can include utilizing the machine learning model. In particular, the act 804 can involve generating the predicted client disposition classification and the disposition classification probability utilizing one or more of a random forest model or gradient boosted decision tree model.

Further, the series of acts 800 can include an act 806 of generating an automated interaction response using the predicted client disposition classification, the disposition classification probability, and a disposition classification threshold. Further, the act 806 can involve generating, utilizing the machine learning model, an additional predicted client disposition classification and an additional disposition classification probability from additional client features and withholding an additional automated interactive response corresponding to the additional predicted client disposition classification based on comparing the additional disposition classification probability and a disposition classification threshold.

As further illustrated in FIG. 8, the series of acts 800 can include an act 808 of providing the automated interaction response to the client via the automated client interaction system. Further, the act 808 of providing an automated interaction response can include initiating a client-agent response session. In particular, the act 808 can include, in response to a user interaction with the automated interaction response, initiating a client-agent response session between the client and an agent device and providing the predicted client disposition classification for display via the agent device.

Further, the act 808 of providing an automated interaction response can include utilizing the predicted client disposition classification, the disposition classification probability, and a disposition classification threshold. In particular, the act 808 can involve determining that the disposition classification probability satisfies the disposition classification threshold and generating the automated interaction response comprising an indicator of the predicted client disposition classification.

Further, the act 808 of providing an automated interaction response can include providing a response to the client via the automated client interaction system. In particular, the act 808 can involve providing an interactive voice response indicating the predicted client disposition classification or providing an automated text response indicating the predicted client disposition classification in a digital message thread.

In addition, the series of acts 800 can involve identifying a client query via the automated client interaction system and in response to identifying the client query, providing the automated interaction response, wherein the automated interaction response comprises an indicator of the predicted client disposition classification.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the client device 108, or the server(s) 106) that may be configured to perform one or more of the processes described above. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requester or provider) to provide input to (such as user strokes), receive output from, and otherwise transfer data to and from the computing device 900. These I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

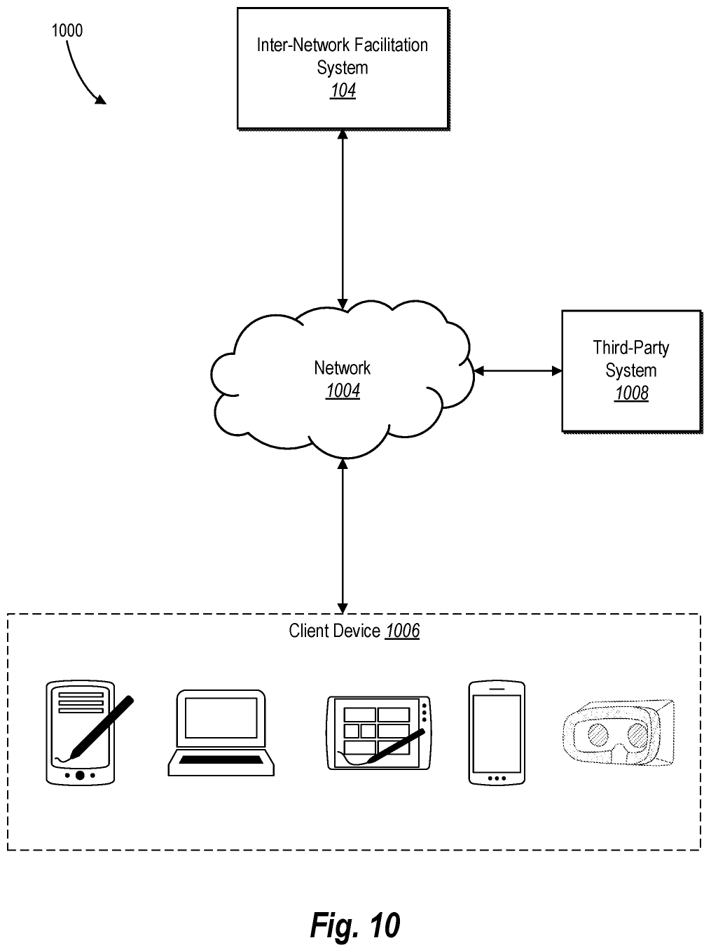

FIG. 10 illustrates an example network environment 1000 of the inter-network facilitation system 104. The network environment 1000 includes a client device 1006 (e.g., client device 108), an inter-network facilitation system 104, and a third-party system 1008 connected to each other by a network 1004. Although FIG. 10 illustrates a particular arrangement of the client device 1006, the inter-network facilitation system 104, the third-party system 1008, and the network 1004, this disclosure contemplates any suitable arrangement of client device 1006, the inter-network facilitation system 104, the third-party system 1008, and the network 1004. As an example, and not by way of limitation, two or more of client device 1006, the inter-network facilitation system 104, and the third-party system 1008 communicate directly, bypassing network 1004. As another example, two or more of client device 1006, the inter-network facilitation system 104, and the third-party system 1008 may be physically or logically co-located with each other in whole or in part.

Moreover, although FIG. 10 illustrates a particular number of client devices 1006, inter-network facilitation systems 104, third-party systems 1008, and networks 1004, this disclosure contemplates any suitable number of client devices 1006, inter-network facilitation system 104, third-party systems 1008, and networks 1004. As an example, and not by way of limitation, network environment 1000 may include multiple client device 1006, inter-network facilitation system 104, third-party systems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006 and third-party system 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 10. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1004) to link the third-party-system 1008. For example, the inter-network facilitation system 104 may receive authentication credentials from a user to link a third-party system 1008 such as an online bank account, credit account, debit account, or other financial account to a user account within the inter-network facilitation system 104. The inter-network facilitation system 104 can subsequently communicate with the third-party system 1008 to detect or identify balances, transactions, withdrawal, transfers, deposits, credits, debits, or other transaction types associated with the third-party system 1008. The inter-network facilitation system 104 can further provide the aforementioned or other financial information associated with the third-party system 1008 for display via the client device 1006. In some cases, the inter-network facilitation system 104 links more than one third-party system 1008, receiving account information for accounts associated with each respective third-party system 1008 and performing operations or transactions between the different systems via authorized network connections.

In particular embodiments, the inter-network facilitation system 104 may interface between an online banking system and a credit processing system via the network 1004. For example, the inter-network facilitation system 104 can provide access to a bank account of a third-party system 1008 and linked to a user account within the inter-network facilitation system 104. Indeed, the inter-network facilitation system 104 can facilitate access to, and transactions to and from, the bank account of the third-party system 1008 via a client application of the inter-network facilitation system 104 on the client device 1006. The inter-network facilitation system 104 can also communicate with a credit processing system, an ATM system, and/or other financial systems (e.g., via the network 1004) to authorize and process credit charges to a credit account, perform ATM transactions, perform transfers (or other transactions) across accounts of different third-party systems 1008, and to present corresponding information via the client device 1006.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1008), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1000 either directly or via network 1004. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1004.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1006. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1006 associated with users.

In addition, the third-party system 1008 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1004. A third-party system 1008 can communicate with the inter-network facilitation system 104 to provide financial information pertaining to balances, transactions, and other information, whereupon the inter-network facilitation system 104 can provide corresponding information for display via the client device 1006. In particular embodiments, a third-party system 1008 communicates with the inter-network facilitation system 104 to update account balances, transaction histories, credit usage, and other internal information of the inter-network facilitation system 104 and/or the third-party system 1008 based on user interaction with the inter-network facilitation system 104 (e.g., via the client device 1006). Indeed, the inter-network facilitation system 104 can synchronize information across one or more third-party systems 1008 to reflect accurate account information (e.g., balances, transactions, etc.) across one or more networked systems, including instances where a transaction (e.g., a transfer) from one third-party system 1008 affects another third-party system 1008.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
extracting client features corresponding to a client of an automated client interaction system;
generating, utilizing a machine learning model, a predicted client disposition classification and a disposition classification probability from the client features;
generating an automated interaction response utilizing the predicted client disposition classification, the disposition classification probability, and a disposition classification threshold; and
providing the automated interaction response to the client via the automated client interaction system.

2. The computer-implemented method of claim 1, further comprising:
identifying a client query via the automated client interaction system; and
in response to identifying the client query, providing the automated interaction response, wherein the automated interaction response comprises an indicator of the predicted client disposition classification.

3. The computer-implemented method of claim 1, further comprising:
in response to a user interaction with the automated interaction response, initiating a client-agent response session between the client and an agent device; and
providing the predicted client disposition classification for display via the agent device.

4. The computer-implemented method of claim 1, further comprising training the machine learning model by:
monitoring client interaction with the automated client interaction system to determine a ground truth client disposition; and
training the machine learning model by comparing the predicted client disposition classification and the ground truth client disposition.

5. The computer-implemented method of claim 1, wherein utilizing the machine learning model comprises generating the predicted client disposition classification and the disposition classification probability utilizing one or more of a random forest model or gradient boosted decision tree model.

6. The computer-implemented method of claim 1, wherein extracting client features comprises:
determining a previous disposition from a previous interaction by the client with the automated client interaction system; and
generating the predicted client disposition classification and the disposition classification probability from the previous disposition utilizing the machine learning model.

7. The computer-implemented method of claim 1, wherein extracting client features comprises one or more of determining a digital account duration, a direct deposit status of a digital account, or application device activity on the digital account.

8. The computer-implemented method of claim 1, wherein generating the automated interaction response utilizing the predicted client disposition classification, the disposition classification probability, and a disposition classification threshold comprises:
determining that the disposition classification probability satisfies the disposition classification threshold; and
generating the automated interaction response comprising an indicator of the predicted client disposition classification.

9. The computer-implemented method of claim 1, further comprising:
generating, utilizing the machine learning model, an additional predicted client disposition classification and an additional disposition classification probability from additional client features; and
withholding an additional automated interactive response corresponding to the additional predicted client disposition classification based on comparing the additional disposition classification probability and a disposition classification threshold.

10. The computer-implemented method of claim 1, wherein providing the automated interaction response to the client via the automated client interaction system further comprises providing an interactive voice response indicating the predicted client disposition classification or providing an automated text response indicating the predicted client disposition classification in a digital message thread.

11. A non-transitory computer-readable medium storing instructions that, when executed by at least one processor, cause a computer system to:
extract client features corresponding to a client of an automated client interaction system;
generate, utilizing a machine learning model, a predicted client disposition classification and a disposition classification probability from the client features;
generate an automated interaction response utilizing the predicted client disposition classification, the disposition classification probability, and a disposition classification threshold; and
provide the automated interaction response to the client via the automated client interaction system.

12. The non-transitory computer-readable medium of claim 11, wherein the instructions, when executed by the at least one processor, further cause the computer system to:
identify a client query via the automated client interaction system; and
in response to identifying the client query, provide the automated interaction response, wherein the automated interaction response comprises an indicator of the predicted client disposition classification.

13. The non-transitory computer-readable medium of claim 11, wherein the instructions, when executed by the at least one processor, further cause the computer system to:
in response to a user interaction with the automated interaction response, initiate a client-agent response session between the client and an agent device; and
provide the predicted client disposition classification for display via the agent device.

14. The non-transitory computer-readable medium of claim 11, wherein the instructions, when executed by the at least one processor, further cause the computer system to:
monitor client interaction with the automated client interaction system to determine a ground truth client disposition; and
train the machine learning model by comparing the predicted client disposition classification and the ground truth client disposition.

15. The non-transitory computer-readable medium of claim 11, wherein utilizing the machine learning model comprises generating the predicted client disposition classification and the disposition classification probability utilizing one or more of a random forest model or gradient boosted decision trees.

16. The non-transitory computer-readable medium of claim 11, wherein the instructions, when executed by the at least one processor, further cause the computer system to:
extract client features by determining a previous disposition from a previous interaction by the client with the automated client interaction system; and
generate the predicted client disposition classification and the disposition classification probability from the previous disposition utilizing the machine learning model.

17. A system comprising:
at least one processor; and
at least one non-transitory computer-readable storage medium storing instructions that, when executed by the at least one processor, cause the system to:
extract client features corresponding to a client of an automated client interaction system;
generate, utilizing a machine learning model, a predicted client disposition classification and a disposition classification probability from the client features;
generate an automated interaction response utilizing the predicted client disposition classification, the disposition classification probability, and a disposition classification threshold; and
provide the automated interaction response to the client via the automated client interaction system.

18. The system of claim 17, further comprising instructions that, when executed by the at least one processor, cause the system to:
identify a client query via the automated client interaction system; and
in response to identifying the client query, provide the automated interaction response, wherein the automated interaction response comprises an indicator of the predicted client disposition classification.

19. The system of claim 17, further comprising instructions that, when executed by the at least one processor, cause the system to:
in response to a user interaction with the automated interaction response, initiate a client-agent response session between the client and an agent device; and
provide the predicted client disposition classification for display via the agent device.

20. The system of claim 17, further comprising instructions that, when executed by the at least one processor, cause the system to:
monitor client interaction with the automated client interaction system to determine a ground truth client disposition; and
train the machine learning model by comparing the predicted client disposition classification and the ground truth client disposition.
